(19) United States
(12) Patent Application Publication
(10) Pub. No.: US 2007/0260907 A1
(43) Pub. Date: Nov. 8, 2007

(54) Technique to modify a timer

(76) Inventors: Martin G. Dixon, Portland, OR (US); Robert J. Greiner, Beaverton, OR (US); Benjamin C. Chaffin, Portland, OR (US)

Correspondence Address: TROP PRUNER & HU, PC, 1616 S. VOSS ROAD, SUITE 750, HOUSTON, TX, 77057-2631, US

(21) Appl. No.: 11/416,647

(22) Filed: May 2, 2006

(51) Int. Cl. G06F 1/00

(52) U.S. Cl. 713/500

(57) ABSTRACT

A technique to modify a timer. More particularly, at least one embodiment of the invention relates to a technique to modify a timer value without the timer advancing by a significant amount.

### BACKGROUND

1. Field

The present disclosure pertains to the field of computing and computer systems, and, more specifically, to the field of timer management in computing devices or systems.

2. Background

In some prior art computer systems and electronic devices, such as microprocessors, may contain circuits, such as a timer, to maintain a running numerical count for use by other logic or devices within the computer system or electronic device. For example, a timer may be used in a microprocessor to count time between events or to maintain a real-time clock.

On occasion, a timer may need to be updated with a new value by a user or some program running within a computer system. For example, in some prior art techniques, a timer value is updated by first reading the current timer value, storing it in some storage location, loading a new timer value from another storage location, and finally programming the new timer value into the timer. Unfortunately, these operations can require time to perform, and therefore some time may pass between the time that the timer value is read from the timer and the time at which the new timer value is programmed into the timer, thereby creating a difference between “real time” and the time that's reflected by the timer.

This problem may be exacerbated as subsequent timer update operations are performed, thereby creating a greater gap between real time and the timer value whenever the timer is updated. The difference between real time and the timer value may cause errors in some programs or processes running in a computer system or that otherwise depend on an accurate timer value. For example, such a gap between real time and a timer value may cause a computer's real time clock to shift over time, which can affect the accuracy of programs, such as calendaring programs, that rely on the timer.

### BRIEF DESCRIPTION OF THE FIGURES

The present invention is illustrated by way of example and not limitation in the accompanying figures.

FIG. 1 illustrates logic that may be used to modify a timer value without losing track of real time, according to one embodiment of the invention.

FIG. 2 is a flow diagram illustrating various operations that may be used in one embodiment of the invention.

FIG. 3 is a shared-bus computer system in which one embodiment of the invention may be used.

FIG. 4 is a point-to-point computer system in which one embodiment of the invention may be used.

### DETAILED DESCRIPTION

Embodiments of the invention relate to computer systems. More particularly, at least one embodiment of the invention relates to a technique to update a timer value while taking into account the advancement of time.

In one embodiment, a timer value is updated using a one or more operations to read the current timer value and update the timer value while taking into account the amount time required to perform the one or more operations. For example, in one embodiment, time corresponding to the amount of time the timer increments (in the case of an “up-timer”) or decrements (in the case of a “down-timer”) may be added/subtracted to/from the update timer value to compensate for the elapsed timer count during the update process.

In some embodiments, the amount of time elapsed during the update process may be reduced by condensing the operations used to update the timer value into a fewer number of operations, than in some prior art timer update techniques. For example, in one embodiment, one operation is used to read the current timer value, update it, and program the updated timer value into the timer. In other embodiments, one operation may be used to read the timer value and update it, and another operation may be used to program the updated timer value into the timer. In yet other embodiments, one operation may be used to read the timer value and another operation may be used to update the time value and program the updated timer value into the timer. Embodiments of the invention, in general, may update a timer using fewer operations than in the prior art as well as compensate the timer value for the time required to update the timer.

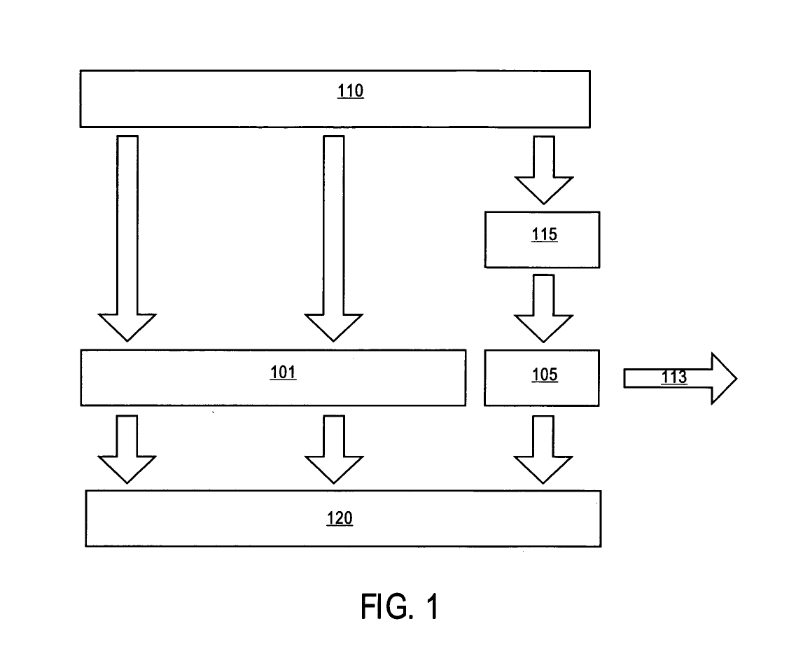

FIG. 1 illustrates logic that may be used to perform one or more aspects of at least one embodiment of the invention. In particular, FIG. 1 illustrates a first timer storage area 101 to store upper (more significant) bits of a current timer value and a second timer storage area 105 to store lower (less significant) bits of the current timer value. The timer storage areas 101 and 105 may correspond to a decrementing timer (“down timer”) or an incrementing timer (“up timer”) or a timer that counts up and down. The values stored in the timer storage areas may be incremented or decremented by other control logic (not shown), in some embodiments.

Also illustrated in FIG. 1 is a third storage area 110 to store a new timer value to be programmed into timer storage areas 101 and 105. In one embodiment an upper number of bits equal to the number of bits to be stored in the first timer storage area 101 may be programmed from the third storage area 110 into the timer storage area 101. A lower number of bits of the new timer value may be used as an operand for an addition or subtraction operation performed by arithmetic unit 115 between the lower number of bits from the third storage area 110 and bits representing an amount of time that has elapsed before the new timer value from the third storage area 110 is programmed into the first timer storage area 101. The sum or difference of the arithmetic operation between the lower order bits of the new timer value and the elapsed time bits may be stored in the second count storage area 105 along with the upper timer bits stored in the first count storage area 101.

In one embodiment, the logic of FIG. 1 also includes an old count storage area 120 to store upper and lower bits of the current count stored in the first and second count storage areas, respectively, so that this count is not over-written by a new timer value. Moreover, the logic of FIG. 1 may also be able to handle an overflow (in the case of an incrementing count) or an underflow (in the case of a decrementing count) condition, in one or more embodiments.

Particularly, in the case of a decrementing timer, or down-timer, an underflow condition may result from the subtraction of the lower order bits of the new timer value and the elapsed time count previously mentioned resulting in a value less than “0”. In this case, the arithmetic unit may indicate this condition by asserting a signal on output 113, which may cause the upper bits to be decremented to account for the elapsed time. In other embodiments, the subtraction operation resulting in a negative number may have no affect on the upper bits. Likewise, if the timer logic of FIG. 1 is to implement an incrementing timer, or up-timer, the addition of the lower order bits of the new count value to the elapsed time bits by the arithmetic unit may cause an overflow condition by generating a bit value that exceeds the size of the count storage area 105, due to a carry bit, for example. In the case of an overflow condition, a signal may be generated on output 113 to indicate that the value stored in the first count storage area 101 should be incrementing to account for the overflow. In other embodiments, the addition operation may have no affect on the upper bits.

In one embodiment, underflow or overflow may be detected by performing a logical AND operation between a carry-out bit from the arithmetic unit and a logical NOR'ed version of the upper bits in count storage area 101. In other embodiments, other techniques may be used to detect an overflow or an underflow condition, including pre-calculating the subtraction or addition operation using microcode. In other embodiments, the underflow or overflow may be calculated using other logic, such as a full adder or subtractor logic.

In one embodiment, a timer value is updated using fewer operations than in the prior art. For example, in one embodiment the timer value stored in the third timer storage area 110 may be read into another storage area (not shown in FIG. 1), such as a register, in which the timer value may be updated and stored back into the third storage area 110 using only one operation, such as an XCHGTMR instruction. In one embodiment, the XCHGTMR instruction may be a complex instruction including a plurality of micro-operations (uops), whereas in other embodiments, the XCHGTMR instruction may include only one uop. In other embodiments, the XCHGTMR itself may be a uop, depending on the instruction set architecture in which the operation is implemented.

Unlike some prior art techniques, at least one embodiment of the invention updates time values without using separate operations or instructions/uops for reading the current timer value, updating the timer value, and then programming the timer with the updated timer value. Particularly, in one embodiment, two or more of these steps, including all three, may be performed by executing one instruction, such as an XCHGTMR instruction.

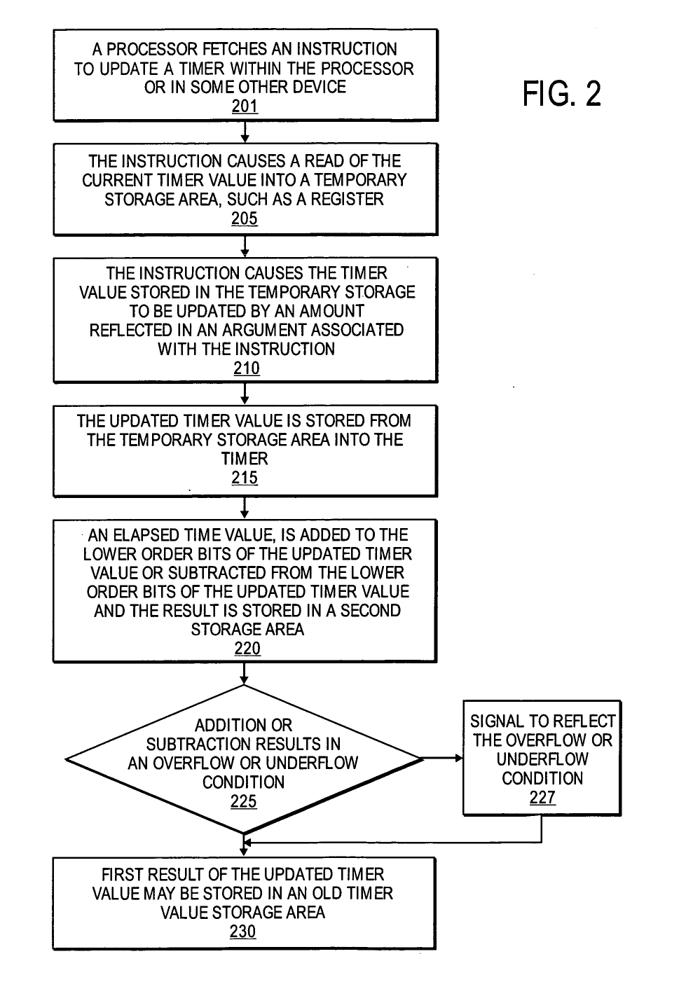

FIG. 2 is a flow diagram illustrating operations that may be performed in carrying out one or more embodiments of the invention. In other embodiments other operations may be performed, including more operations or fewer operations. At operation 201, a processor fetches an instruction to update a timer within the processor or in some other device. At operation 205, the instruction causes a read of the current timer value into a temporary storage area, such as a register, at operation 210 the instruction causes the timer value stored in the temporary storage to be updated by an amount reflected in an argument associated with the instruction, and at operation 215 the updated timer value is stored from the temporary storage area into the timer.

At operation 220, the upper bits of the updated timer value is stored in a first storage area, such as a register, while an elapsed time value, reflecting the time from when the timer value was read by the instruction until the updated timer value is stored into the timer, is added (in the case of an up-timer) to the lower order bits of the updated timer value or subtracted (in the case of a down-timer) from the lower order bits of the updated timer value and the result is stored in a second storage area, such as a second register. In one embodiment, if the addition or subtraction results in an overflow or underflow condition, respectively, at operation 225, then this is indicated by a signal to reflect the overflow or underflow condition in the upper bits of the updated timer value stored in the first storage area at operation 227. At operation 230, the final result of the updated timer value (post-underflow/overflow adjustment) may be stored in an old timer value storage area, such as a register, so that it is not overwritten by a subsequent timer value update.

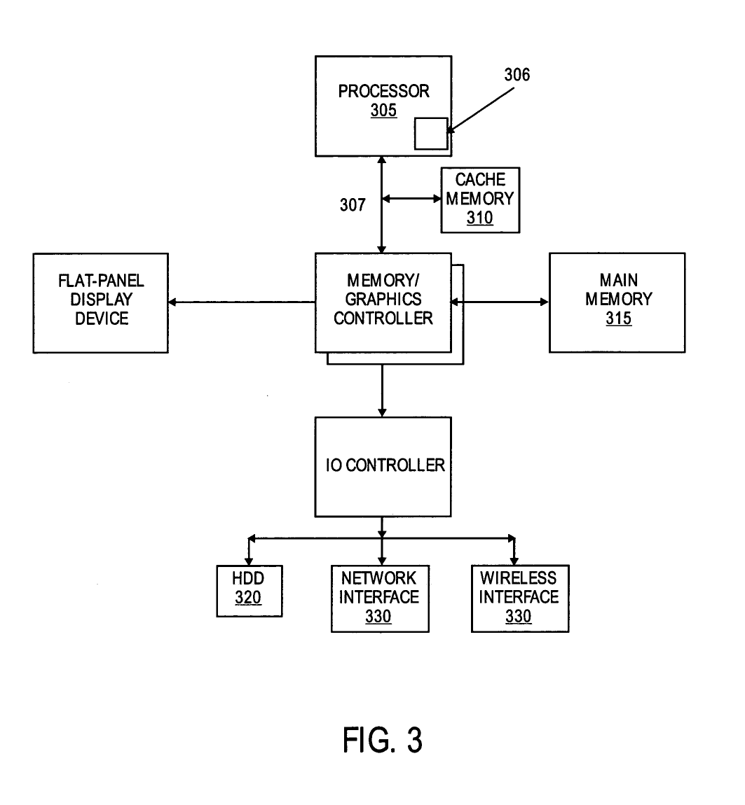

FIG. 3 illustrates a front-side-bus (FSB) computer system in which one embodiment of the invention may be used. A processor 305 accesses data from a level one (L1) cache memory 310 and main memory 315. In other embodiments of the invention, the cache memory may be a level two (L2) cache or other memory within a computer system memory hierarchy. Furthermore, in some embodiments, the computer system of FIG. 3 may contain both an L1 cache and an L2 cache.

Illustrated within the processor of FIG. 3 is a storage area 306 for machine state. In one embodiment storage area may be a set of registers, whereas in other embodiments the storage area may be other memory structures. Also illustrated in FIG. 3 is a storage area 307 for save area segments, according to one embodiment. In other embodiments, the save area segments may be in other devices or memory structures. The processor may have any number of processing cores. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 320, or a memory source located remotely from the computer system via network interface 330 containing various storage devices and technologies. The cache memory may be located either within the processor or in close proximity to the processor, such as on the processor's local bus 307.

Furthermore, the cache memory may contain relatively fast memory cells, such as a six-transistor (6T) cell, or other memory cell of approximately equal or faster access speed. The computer system of FIG. 3 may be a point-to-point (PtP) network of bus agents, such as microprocessors, that communicate via bus signals dedicated to each agent on the PtP network. FIG. 5 illustrates a computer system that is arranged in a point-to-point (PtP) configuration. In particular, FIG. 5 shows a system where processors, memory, and input/output devices are interconnected by a number of point-to-point interfaces.

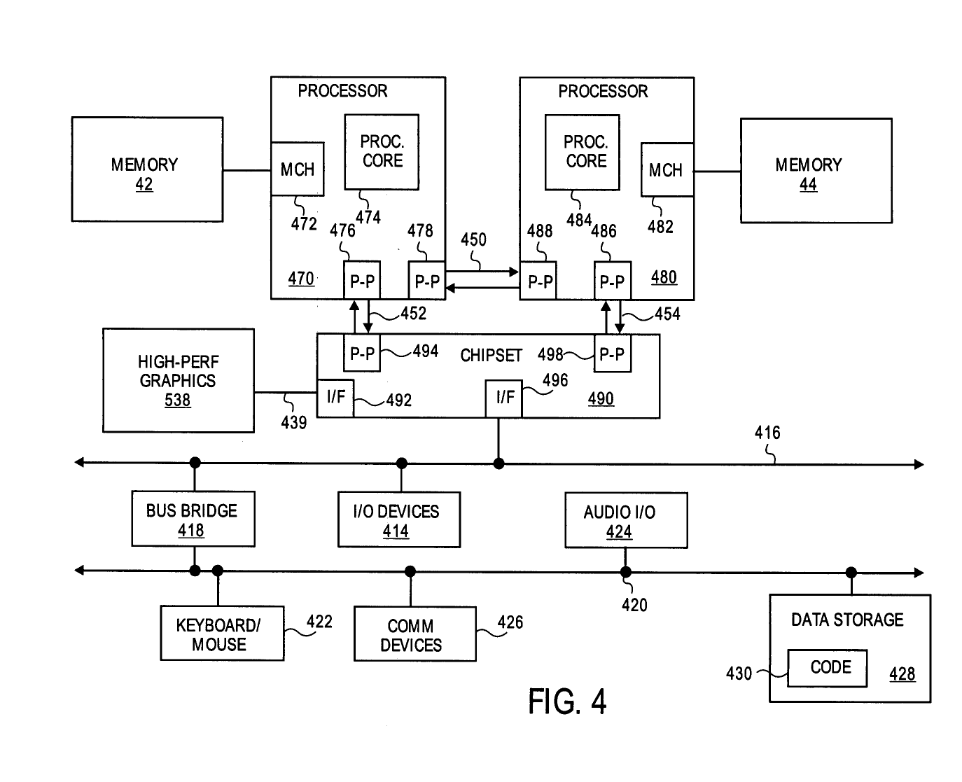

The system of FIG. 4 may also include several processors, of which only two, processors 470, 480 are shown for clarity. Processors 470, 480 may each include a local memory controller hub (MCH) 472, 482 to connect with memory 22, 24. Processors 470, 480 may exchange data via a point-to-point (PtP) interface 450 using PtP interface circuits 478, 488. Processors 470, 480 may each exchange data with a chipset 490 via individual PtP interfaces 452, 454 using point to point interface circuits 476, 494, 486, 498. Chipset 490 may also exchange data with a high-performance graphics circuit 438 via a high-performance graphics interface 439. Embodiments of the invention may be located within any processor having any number of processing cores, or within each of the PtP bus agents of FIG. 4.

Processors referred to herein, or any other component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for steering memory accesses, such as loads or stores are disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

Various aspects of one or more embodiments of the invention may be described, discussed, or otherwise referred to in an advertisement for a processor or computer system in which one or more embodiments of the invention may be used. Such advertisements may include, but are not limited to news print, magazines, billboards, or other paper or otherwise tangible media. In particular, various aspects of one or more embodiments of the invention may be advertised on the internet via websites, “pop-up” advertisements, or other web-based media, whether or not a server hosting the program to generate the website or pop-up is located in the United States of America or its territories.

1. A machine-readable medium having stored thereon an instruction, which if performed by a machine causes the machine to perform a method comprising:
reading a current timer value;
updating the current timer value to an updated timer value;
storing the updated timer value into a timer storage area.

2. The machine-readable medium of claim 1, wherein the reading, updating, and storing are to be performed in response to a processor performing only one micro-operation.

3. The machine-readable medium of claim 1, wherein the updated timer value is to be adjusted to compensate for an amount of elapsed time between the reading and the storing.

4. The machine-readable medium of claim 1, wherein the current timer value is to be stored in a temporary storage area as a result of the reading.

5. The machine-readable medium of claim 3, wherein bits representing the amount of elapsed time are to be subtracted from a lower portion of bits representing the updated timer value.

6. The machine-readable medium of claim 3, wherein bits representing the amount of elapsed time are to be added to a lower portion of bits representing the updated timer value.

7. The machine-readable medium of claim 5, wherein a signal is to be generated in response to an underflow condition resulting from the subtraction.

8. The machine-readable medium of claim 6, wherein a signal is to be generated in response to an overflow condition resulting from the addition.

9. An apparatus comprising:
a first storage area to store an upper group of bits representing a current timer value;
a second storage area to store a lower group of bits representing the current timer value;
an arithmetic unit to modify a value represented by the lower group of bits in response to an amount of time elapsed during an update of the current timer value.

10. The apparatus of claim 9, wherein the arithmetic unit includes a subtract unit to subtract bits representing the elapsed time from the lower group of bits.

11. The apparatus of claim 10, wherein the arithmetic unit is to generate a signal to represent an underflow condition resulting from the subtraction.

12. The apparatus of claim 11, wherein the underflow condition is to be detected by performing a logical AND operation between the result of the subtraction and a logical NOR'ed version of the upper group of bits.

13. The apparatus of claim 9, wherein the arithmetic unit includes an add unit to add bits representing the elapsed time to the lower group of bits.

14. The apparatus of claim 13, wherein the arithmetic unit is to generate a signal to represent an underflow condition resulting from the addition.

15. The apparatus of claim 14, wherein the underflow condition is to be detected by performing a logical AND operation between the result of the addition and a logical NOR'ed version of the upper group of bits.

16. The apparatus of claim 9 further including an old timer value storage area to store a concatenated version of the upper and lower group of bits.

17. A system comprising:
a memory to store a first instruction;
a processor to execute the first instruction, wherein executing only the first instruction is to cause a timer to be updated.

18. The system of claim 17, wherein only one micro-operation associated with the first instruction is to cause the timer to be updated.

19. The system of claim 17, wherein the first instruction is to cause a current timer value to be read and stored in a temporary register.

20. The system of claim 19, wherein the first instruction is to cause the current timer value stored in the temporary register to be updated with an updated timer value.

21. The system of claim 20, wherein the first instruction is to cause the updated timer value to be programmed into the timer.

22. The system of claim 21, wherein the updated timer value is to be modified to compensate for a time delay between the current timer value being read into the temporary register and when the updated timer value is programmed into the timer.

23. The system of claim 17, wherein the timer is to be updated with an updated timer value reflecting the delay associated with updating the timer.

24. The system of claim 23, wherein the timer is a decrementing timer.

25. A method comprising:
fetching a first instruction;
in response to fetching the first instruction:
copying a current timer value into a temporary storage area;
storing an updated timer value into the temporary storage area;
programming a timer with updated timer value;
storing the updated timer value in an old timer value storage area.

26. The method of claim 25 further comprising storing an upper group bits representing the updated timer value and storing a lower group of bits representing the updated timer value.

27. The method of claim 26 further comprising adding or subtracting an elapsed time between the copying to the programming, depending on whether the timer is down-counting or up-counting.

28. The method of claim 27 further comprising indicating whether the adding or subtracting has resulted in an overflow or underflow condition, respectively.

29. The method of claim 28 further comprising adjusting the updated timer value in response to the overflow or underflow condition.

30. The method of claim 25, wherein the instruction includes only one micro-operation.
